(19) United States
(12) Patent Application Publication
(10) Pub. No.: US 2025/0047119 A1
(43) Pub. Date: Feb. 6, 2025

(54) BATTERY PACK WITH A BI-DIRECTIONAL SWITCH AND ASSOCIATED DRIVER CIRCUIT AND CONTROL METHOD

(71) Applicant: Chengdu Monolithic Power Systems Co., Ltd., Chengdu (CN)

(72) Inventor: Shuai Wang, Hangzhou (CN)

(21) Appl. No.: 18/787,596

(22) Filed: Jul. 29, 2024

(30) Foreign Application Priority Data
Jul. 31, 2023 (CN) 202310955939.2

(51) Int. Cl. H02J 7/00; H01M 10/42; H01M 10/44

(52) U.S. Cl. CPC H02J 7/00712; H01M 10/425; H01M 10/44; H01M 2010/4271; H02J 7/0029

(57) ABSTRACT

A control method for a battery pack with a monolithic bi-directional switch is provided. The bi-directional switch has a first electrode coupled to a battery, a second electrode coupled to a pack terminal, and a control electrode. The control method includes providing a charge control signal and a discharge control signal, and controlling the bi-directional switch based on the charge control signal and the discharge control signal. A current is allowed to flow bi-directionally between the first electrode and the second electrode when the bi-directional switch is turned on. There is no current flowing between the first electrode and the second electrode when the bi-directional switch is turned off.

### CROSS-REFERENCE TO RELATED APPLICATIONS

This application claims the benefit of CN application 202310955939.2, filed on Jul. 31, 2023, and incorporated herein by reference.

### TECHNICAL FIELD OF THE INVENTION

The present invention generally relates to electronic circuits, and more particularly but not exclusively, to a battery pack with a bi-directional switch and associated driver circuit and control method.

### BACKGROUND OF THE INVENTION

Secondary batteries (e.g., rechargeable batteries) have become a hot research topic with the development of portable electronic devices such as E-bikes, E-scooters, and power gardening tools.

### SUMMARY OF THE INVENTION

An embodiment of the present invention discloses a driver circuit for a battery pack with a monolithic bi-directional switch. The driver circuit is coupled to a control electrode of the bi-directional switch and is configured to control the bi-directional switch based on a charge control signal and a discharge control signal. A current is allowed to flow bi-directionally between a first electrode configured to be coupled to a battery and a second electrode configured to be coupled to a pack terminal when the bi-directional switch is turned on by the driver circuit, and there is no current flowing between the first electrode and the second electrode when the bi-directional switch is turned off by the driver circuit.

Another embodiment of the present invention discloses a battery pack. The battery pack comprises a monolithic bi-directional switch, a battery management circuit, and a driver circuit. The bi-directional switch has a first electrode coupled to a battery, a second electrode coupled to a pack terminal, and a control electrode. The battery management circuit is configured to provide a charge control signal and a discharge control signal. The driver circuit is coupled to the control electrode and is configured to control the bi-directional switch based on the charge control signal and the discharge control signal. A current is allowed to flow bi-directionally between the first electrode and the second electrode when the bi-directional switch is turned on by the driver circuit, and there is no current flowing between the first electrode and the second electrode when the bi-directional switch is turned off by the driver circuit.

Yet another embodiment of the present invention discloses a control method for a battery pack with a monolithic bi-directional switch. The bi-directional switch has a first electrode coupled to a battery, a second electrode coupled to a pack terminal, and a control electrode. The control method comprises the flowing steps. A charge control signal and a discharge control signal are provided. The bi-directional switch is controlled based on the charge control signal and the discharge control signal. A current is allowed to flow bi-directionally between the first electrode and the second electrode when the bi-directional switch is turned on, and there is no current flowing between the first electrode and the second electrode when the bi-directional switch is turned off.

### BRIEF DESCRIPTION OF DRAWINGS

The present invention can be further understood with reference to the following detailed description and the appended drawings, wherein like elements are provided with like reference numerals.

FIG. 1 schematically shows a traditional battery pack 10.

FIG. 2 shows a battery pack 100 in accordance with one embodiment of the present invention.

FIG. 3 shows a battery pack 100A in accordance with one embodiment of the present invention.

FIG. 4 shows a drive signal control unit 401A and a voltage clamp unit 402A in accordance with one embodiment of the present invention.

FIG. 5 shows a first pull-down circuit 403A and a second pull-down circuit 404A in accordance with one embodiment of the present invention.

FIG. 6 shows a battery pack 100B in accordance with one embodiment of the present invention.

FIG. 7 shows a third pull-down circuit 405A in accordance with one embodiment of the present invention.

FIG. 8 shows a battery pack 100C in accordance with one embodiment of the present invention.

FIG. 9 shows a fourth pull-down circuit 406A in accordance with one embodiment of the present invention.

FIG. 10 shows a battery pack 100D in accordance with one embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to “one embodiment”, “an embodiment”, “an example” or “examples” means: certain features, structures, or characteristics are contained in at least one embodiment of the present invention. These “one embodiment”, “an embodiment”, “an example” and “examples” are not necessarily directed to the same embodiment or example. Furthermore, the features, structures, or characteristics may be combined in one or more embodiments or examples. In addition, it should be noted that the drawings are provided for illustration, and are not necessarily to scale. And when an element is described as “connected” or “coupled” to another element, it can be directly connected or coupled to the other element, or there could exist one or more intermediate elements. In contrast, when an element is referred to as “directly connected” or “directly coupled” to another element, there is no intermediate element.

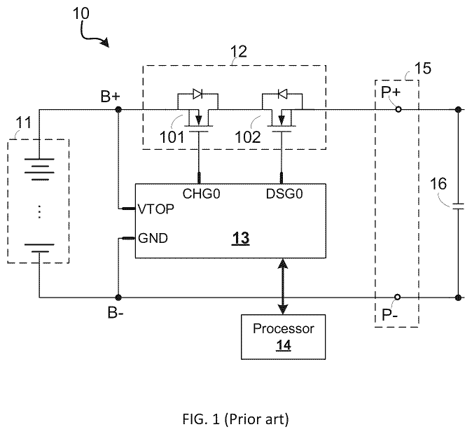

FIG. 1 schematically shows a traditional battery pack 10. As shown in FIG. 1, the battery pack 10 comprises a battery 11, a charge and discharge circuit 12, a battery management integrated circuit 13, a processor 14 and pack terminals 15 (i.e., P+ and P−).

The battery 11 may comprise one or more battery cells. The charge and discharge circuit 12 comprises a charge switch 101 and a discharge switch 102. The charge switch 101 and the discharge switch 102 are coupled in series and arranged between the battery 11 and the pack terminals 15. The battery management integrated circuit 13 is used as a protection and management unit of the battery pack 10. The battery management integrated circuit 13 is coupled to the battery 11 and the processor 14, and respectively provides a charge control signal CHG0 and a discharge control signal DSG0, to control the charge switch 101 and the discharge switch 102, respectively. The battery pack 10 may be coupled to a load or an external power supply through the battery pack terminals 15. When the external power supply is connected to the battery pack 10 through the pack terminals 15, the battery 11 is charged by the external power supply via the charge switch 101 and the discharge switch 102 or a parasitic diode D2 of the discharge switch 102. When the load is connected to the battery pack 10 through the pack terminals 15, the battery 11 discharges to the load via the charge switch 101 or a parasitic diode of the charge switch 101 and the discharge switch 102. The load may include a capacitor 16 charged by the battery pack 10 and electronic devices driven by electrical charge stored in the capacitor 16.

However, there are some undesired drawbacks for the charge and discharge circuit 12. As shown in FIG. 1, the charge and discharge circuit 12 has two MOSFETs coupled in series, and thus it requires a larger circuit area. In addition, the on-resistances of the two MOSFETs coupled in a series are added and doubled, which causes power loss when discharging with a high current, the power is wasted and dissipated by the charge and discharge circuit 12. As a result, the overall system efficiency is not good and there will be a serious thermal problem.

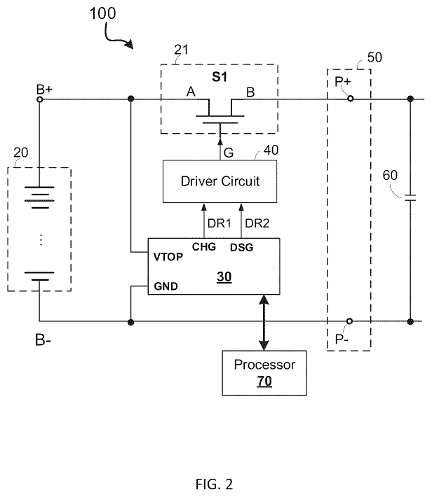

FIG. 2 shows a battery pack 100 in accordance with one embodiment of the present invention. As shown in FIG. 2, the battery pack 100 comprises a battery 20, a charge and discharge circuit 21, a battery management circuit 30, a driver circuit 40 and pack terminals 50 (i.e., P+ and P−).

The battery 20 comprises one or more battery cells. Each battery cell may comprise a rechargeable secondary battery, for example, a nickel-chromium battery, a lead battery, a nickel metal oxide battery, a lithium-ion battery, or a lithium-polymer battery. The charge and discharge circuit 21 comprises a monolithic bi-directional switch S1. The bi-directional switch S1 is coupled between the battery 20 and the pack terminals 50. The driver circuit 40 is configured to control the bi-directional switch S1 based on a charge control signal DR1 and a discharge control signal DR2 for providing protection between the battery 20 and a load in both directions. The load comprises a capacitor 60 charged by the battery pack 100 and electronic devices driven by the electrical energy stored on the capacitor 60.

The charge and discharge circuit 21 shown in FIG. 2 is a key element that has the ability of bi-directional protection. In the embodiment shown in FIG. 2, the charge and discharge circuit 21 is coupled between a positive terminal B+ of the battery 20 and a positive pack terminal P+ of the battery pack 100. In another embodiment, the charge and discharge circuit 21 may be coupled between a negative terminal B− of the battery 20 and a negative pack terminal P− of the battery pack 100.

In the embodiment shown in FIG. 2, the monolithic bi-directional switch S1 comprises a wide bandgap semiconductor device, e.g., a GaN (Gallium Nitride). The wide bandgap semiconductor devices have the advantages of wider bandgap, higher breakdown field strength and higher saturated electron drift velocity. Furthermore, the wide bandgap semiconductor devices lack parasitic body diode. In addition, the wide bandgap semiconductor device also have a better performance on high temperature resistance and have a small size. In one embodiment, the bi-directional switch S1 has the ability to allow the current flowing in both directions and the ability to block the current in both directions.

In the embodiment shown in FIG. 2, the monolithic bi-directional switch S1 is used in the battery pack 100 to control and to protect of the charging and discharging. Compared with the two MOSFETs connected in series shown in FIG. 1, the monolithic bi-directional switch S1 shown in FIG. 2 has a smaller size, which can not only save circuit cost, but also provide more effective control and reduce the loss.

In the embodiment shown in FIG. 2, the battery management circuit 30 is an integrated circuit. The battery management circuit 30 is configured to monitor the status and safety of the battery 20. In one embodiment, the battery management circuit 30 can monitor voltage and/or temperature of the battery 20 based on voltage sampling value and/or temperature sampling value to the battery 20, so that the battery 20 is kept in a safe state. In one embodiment, the battery management circuit 30 may be an analog front end (AFE).

In one embodiment, a processor 70 is further used and configured to perform internal control and management of the battery pack 100, for example, to discharge to a load or to charge the battery pack 100, so that an output voltage provided by the battery pack 100 can adapt to electronic devices with multiple operating voltages. In one embodiment, the processor 70 may comprise a micro control unit (MCU), an application specific integrated circuit (ASIC), a programmable logic device (PLD), or a microcontroller, etc.

The battery management circuit 30 is coupled to the battery 20 and the processor 70. The battery management circuit 30 is configured to monitor operating data of the battery 20 and to transmit the operating data to the processor 70 for ensuring the safety and reliability of the battery pack 100. The operating data may comprise battery cell voltages, battery temperature, pack terminal voltages, etc. The battery management circuit 30 is configured to provide the charge control signal DR1 and the discharge control signal DR2 to the driver circuit 40 via a charge control terminal CHG and a discharge control terminal DSG of the battery management circuit 30. The driver circuit 40 is configured to control the turning-on and turning-off of the bi-directional switch S1, and ultimately to charge the battery 20 or to discharge to the load. The battery management circuit 30 further comprises a supply terminal VTOP coupled to the positive battery terminal B+ and a reference ground terminal GND coupled to the negative battery terminal B−, as shown in FIG. 2.

In the embodiment shown in FIG. 2, the driver circuit 40 is coupled to the charge control terminal CHG and the discharge control terminal DSG of the battery management circuit 30. The bi-directional switch S1 has a first electrode A coupled to the battery 20, a second electrode B coupled to a pack terminal p+, and a control electrode G. An output terminal of the driver circuit 40 is coupled to the control electrode G of the bi-directional switch S1. Based on the charge control signal DR1 and the discharge control signal DR2, the bi-directional switch S1 is controlled. In detail, the charge control signal DR1 is configured to allow or prevent charging to the battery 20. The discharge control signal DR2 is configured to allow or prevent the discharging from the battery 20 to the load. In detail, a current is allowed to flow bi-directionally between the first electrode A and the second electrode B when the bi-directional switch S1 is turned on, and there is no current flowing between the first electrode A and the second electrode B when the bi-directional switch S1 is turned off.

In applications, the wide bandgap semiconductor devices have strict requirements on a drive voltage applied to the control electrode G. In one embodiment, the drive voltage is required to be kept less than 6V, and is typically 5V. If the drive voltage applied the control electrode G is too high, it will cause the semiconductor device to burn out. If the drive voltage applied the control electrode G is too low, it will affect the conduction capability due to the increasing ON resistance, to increase the power loss. Therefore, the driver circuit 40 needs to be designed for controlling the bi-directional switch S1, to ensure work with good performance.

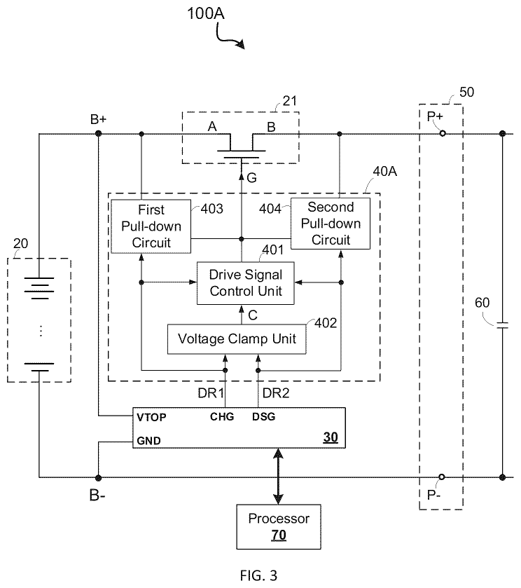

FIG. 3 shows a battery pack 100A in accordance with one embodiment of the present invention. In the embodiment shown in FIG. 3, the driver circuit 40A comprises a driver signal control unit 401, a voltage clamp unit 402, a first pull-down circuit 403 and a second pull-down circuit 404.

In the embodiment shown in FIG. 3, the bi-directional switch 21 is configured to have the ability to conduct and block in both directions. The bi-directional switch 21 has the first electrode A, the second electrode B and the control electrode G. The first electrode A is coupled to the positive terminal B+ of the battery 20, the second electrode B is coupled to the positive pack terminal P+ of the battery pack 100A, and the control electrode G is coupled to the output terminal of the driver circuit 40A to receive an adjusted drive voltage (for example, 5V) to control the turning-on and the turning-off of the bi-directional switch 21.

In the embodiment shown in FIG. 3, the drive signal control unit 401 is configured to transmit the drive voltage to the control electrode G of the bi-directional switch S1 by activating or deactivating a driving path based on the charge control signal DR1 and the discharge control signal DR2. The voltage clamp unit 402 has a first input terminal, a second input terminal and an output terminal. The first input terminal of the voltage clamp unit 402 receives the charge control signal DR1. The second input terminal of the voltage clamp unit 402 receives the discharge control signal DR2. In response to the charge control signal DR1 and the discharge control signal DR2, the voltage clamp unit 402 provides the drive voltage to the control electrode G of the bi-directional switch S1 via the drive signal control unit 401. In one embodiment, the voltage clamp unit 402 can be omitted.

In detail, during normal operation of charging or discharging, the charge control signal DR1 provided at the charge control terminal CHG of the battery management circuit 30 is at high level, and the discharge control signal DR2 provided at the discharge control terminal DSG of the battery management circuit 30 is also at high level, the driving path provided by the drive signal control unit 401 is activated and in an ON state, the voltage clamp unit 402 is also activated. The drive voltage that is greater than a turn-on threshold voltage is transmitted to the control electrode G. The bi-directional switch S1 is turned on, and the current is allowed to flow in both directions between the first electrode A and the second electrode B. In detail, during normal operation of charging, the battery 20 is being charged, the bi-directional switch 21 is turned on in response to the high level of the charge control signal DR1, and the current flows from the second electrode B to the first electrode A. During normal operation of discharging, the battery pack 100 discharges to the load, the bi-directional switch 21 is turned on in response to the high level of the discharge control signal DR2, and the current flows from the first electrode A to the second electrode B.

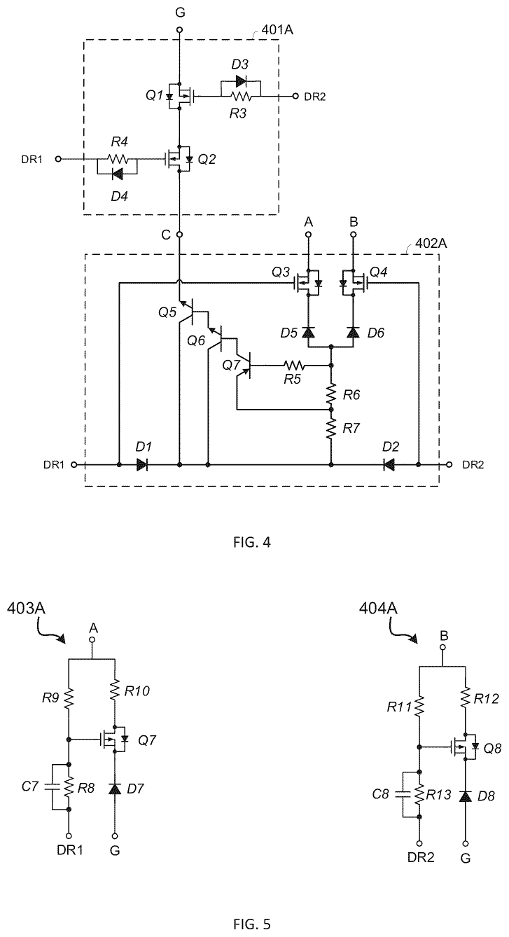

FIG. 4 shows a drive signal control unit 401A and a voltage clamp unit 402A in accordance with one embodiment of the present invention. As shown in FIG. 4, the voltage clamp unit 402A comprises a first set of voltage clamp elements D1 and D2, resistors R5˜R7, transistors Q3˜Q5, and a second set of voltage clamp elements D5 and D6.

The first set of voltage clamp elements D1 and D2 are configured to unidirectionally isolate from the charge control terminal CHG and the discharge control terminal DSG, respectively. Under normal operation, although the voltage at the charge control terminal CHG and the voltage at the discharge control terminal DSG are different, the battery management circuit 30, the voltage clamp unit 402 and the bi-directional switch S1 still can be controlled normally. In one embodiment, the voltage clamp elements D1 and D2 may have substantially the same forward voltage drop.

The second set of voltage clamp elements D5 and D6, the transistors Q3 and Q4 are configured to select a lower of the voltage at the first electrode A or the voltage at the second electrode B as a drive reference voltage. In one embodiment, a path for providing the drive reference voltage is always activated. In another embodiment, the path for providing the drive reference voltage can be activated or disactivated based on the charge control signal DR1 and the discharge control signal DR2. For example, when at least one of the charge control signal DR1 and the discharge control signal DR2 becomes high level, the path for providing the drive reference voltage is activated. In one embodiment, the drive reference voltage can be adjusted to be the suitable drive voltage required by the control electrode G of the bi-directional switch S1 through the transistors Q5˜Q7, to make sure the bi-directional switch S1 operate normally. In one embodiment, the voltage clamp unit 402 is configured to provide the drive voltage of about 5V at a node C based on the charge control signal DR1 and the discharge control signal DR2.

The drive signal control unit 401A is configured to activate and disactivate the driving path based on the control logic. In detail, the drive signal control unit 401A is configured to provide the driving path for transmitting the drive voltage to the control electrode G based on the charge control signal DR1 and the discharge control signal DR2. In the embodiment shown in FIG. 4, the drive signal control unit 401A comprises transistors Q1 and Q2, voltage clamp elements D3 and D4, and resistors R3 and R4. When the charge control signal DR1 and the discharge control signal DR2 are both at high level, the transistors Q1 and Q2 are both turned on, and the drive voltage provided by the voltage clamp unit 402A at the node C is transmitted to the control electrode G for turning on the bi-directional switch S1. When any one of the charge control signal DR1 and the discharge control signal DR2 becomes low level, the driving path is cut off. In one embodiment, when the discharge control signal DR2 becomes high level and the charge control signal DR1 becomes low level, the transistor Q1 is turned off and the transistor Q2 is turned on. When the load coupled to pack terminals 50 draws a current, the output voltage provided by the battery pack 100A decrease, and the drive voltage transmitted to the control electrode G decreases accordingly. When the voltage difference between the charge control signal DR1 and the control electrode G is greater than a threshold voltage of the transistor Q1, the transistor Q1 is also turned on, and the driving path will be activated and in the ON state, to allow the battery pack 100A to discharge to the load via the bi-directional switch S1. The charging to the battery 20 is blocked. The bi-directional switch S1 operates similarly as a unidirectional diode or a unidirectional clamp element.

In another embodiment, when the charge control signal DR1 becomes high level and the discharge control signal DR2 is at low level, the transistor Q1 is turned on and the transistor Q2 is turned off. When the pack terminals 50 are connected to the external power supply, the voltage of the discharge control signal DR2 is increased. When the voltage difference between the discharge control signal DR2 and the control electrode G exceeds a turning-on threshold of the transistor Q2, the transistor Q2 is turned on, thereby allowing the battery pack 100 to charge the battery 20 via the bi-directional switch S1, to prevent the battery 20 from being discharged.

Referring still to FIG. 3, when the pack terminals 50 of the battery pack 100 are coupled to the external power supply, the external power supply charges the battery 20 via the bi-directional switch S1, if it is detected that the battery pack voltage is charged to reach an overcharge threshold voltage, the charge control signal DR1 becomes low level while the discharge control signal DR2 remains high level. A first pull-down path provided by the first pull-down circuit 403 is activated, to pull the control electrode G down to the first electrode A, and the bi-directional switch S1 is turned off to cut off the connection of the battery 20 and the external power supply, the charging is blocked, to protect the battery 20 from an overcharging or an overcurrent.

When the battery 20 discharges to the load via the bi-directional switch S1, if the overcurrent is detected or the battery 20 is fully discharged, the charge control signal DR1 remains high level and the discharge control signal DR2 becomes low level. The second pull-down path provided by the second pull-down circuit 402 is activated, the voltage of the control electrode G is pulled down to the voltage of the second electrode B, the bi-directional switch S1 is turned off, and the discharging is stopped to disconnect the battery 20 from the load and to prevent the battery from being discharged, and thus to protect the battery from an over-discharge or over-current.

FIG. 5 shows a first pull-down circuit 403A and a second pull-down circuit 404A in accordance with one embodiment of the present invention. As shown in FIG. 5, the first pull-down circuit 403A comprises a transistor Q7, a voltage clamp element D7, resistors R8˜R10, and a capacitor C7. When the charge control signal DR1 becomes low level, a gate voltage of the transistor Q7 becomes high level, the transistor Q7 is turned on, and the voltage of the control electrode G is clamped to the voltage of the first electrode A through the forward-biased voltage clamp element D7, to prevent the battery 20 from being charged via the bi-directional switch S1, and thus the charging to the battery 20 is stopped. When the charge control signal DR1 becomes high level, the transistor Q7 is turned off, the first pull-down path provided by the first pull-down circuit 403A is disactivated, the clamp to the control electrode G is released, and the charging to the battery 20 is allowed.

The second pull-down circuit 404A has a similar circuit structure to the first pull-down circuit 403A, and therefore also has a similar working principle. As shown in FIG. 5, the second pull-down circuit 404A comprises a transistor Q8, a voltage clamp element D8, resistors R11˜R13, and a capacitor C8. When the discharge control signal DR2 becomes low level, the transistor Q8 is turned on, and the voltage of the control electrode G is clamped to the voltage of the second electrode B through the forward-biased voltage clamp element D8, to prevent the battery 20 being discharged via the bi-directional switch S1. When the charge control signal DR2 becomes high level, the transistor Q8 is turned off, the second pull-down path provided by the second pull-down circuit 404A is disactivated, the clamp to the control electrode G is released, and the discharging from the battery 20 is allowed.

In some embodiments, when the voltage of the control electrode G of the bidirectional switch S1 is equal to zero or close to zero, a leakage current from the first electrode A to the second electrode B is still very high, which may be 10 times of the leakage current of the charge and discharge circuit 12 shown in FIG. 1. When the temperature is high, the leakage current can be even higher. For the battery management application, the significant leakage current can consume energy from the battery 20 and cause excessive battery discharge when the battery pack 100 is stored for a long time. When the driving path is in OFF state but there is the leakage current, the voltage at the positive pack terminal P+ of the battery pack 100 will rise. In some worse cases, the voltage at the pack terminal P+ will rise to 36V, which is very dangerous for an operator. In addition, since the leakage current will cause the voltage at the positive pack terminal P+ to rise, which will cause confusion in the detection logic of the battery management system.

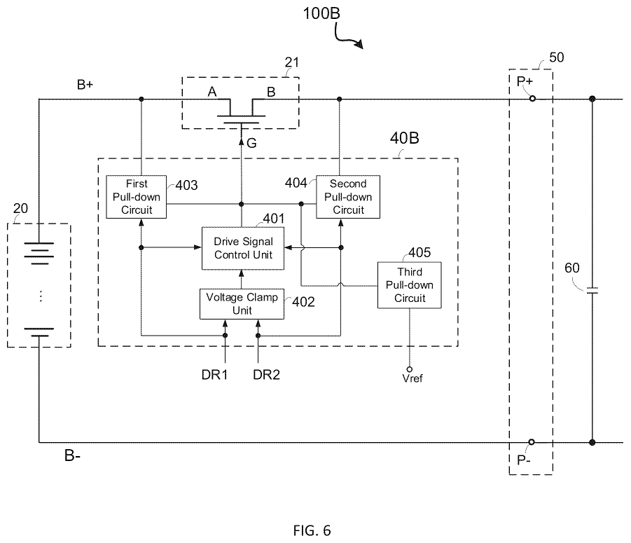

For this reason, in order to reduce the leakage current when the bi-directional switch S1 is turned off, the embodiment shown in FIG. 6 is proposed. FIG. 6 shows a battery pack 100B in accordance with one embodiment of the present invention. In the embodiment shown in FIG. 6, the driver circuit 40B further comprises a third pull-down circuit 405.

The third pull-down circuit 405 has a first terminal coupled to the control electrode G of the bidirectional switch S1 and a second terminal coupled to receive a reference voltage Vref at a reference node. In one embodiment, the pull-down path provided by the third pull-down circuit 405A may be always activated for sinking a current from the control electrode G to the reference node. In one embodiment, a resistor is disposed between the control electrode G and the reference voltage Vref. In another embodiment, for better performance, the reference voltage Vref could be coupled to a reference ground, as shown in FIG. 6. In order to reduce system power loss, the third pull-down circuit 405 may be activated when at least one of the charge control signal CHG and the discharge control signal DSG becomes low level.

When the bi-directional switch S1 remains in the OFF state, the third pull-down circuit 405 is configured to sink a current from the control electrode G to the reference ground and to pull the control electrode G down to the reference ground. When the bi-directional switch S1 is turned off, the leakage current will cause the output voltage of the battery pack 100B (i.e., the voltage at the positive pack terminal P+) to increase (for example, to increase 0.5V). In this way, the voltage drop VGB between the control electrode G and the second electrode B is −0.5V. This voltage drop VGB is negative and could greatly reduce the leakage current. The output voltage of the battery pack 100B will be maintained at a safe and acceptable low voltage range, thereby protecting the safety of the system.

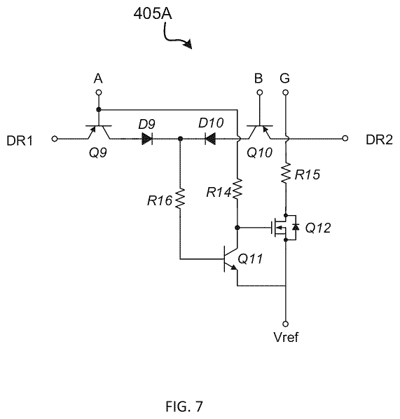

FIG. 7 shows a third pull-down circuit 405A in accordance with one embodiment of the present invention. As shown in FIG. 7, the third pull-down circuit 405A comprises transistors Q9˜Q12, resistors R14˜R16, and voltage clamp elements D9 and D10. As shown in FIG. 7, when the charge control signal DR1 and the discharge control signal DR2 are both low levels, the transistor Q11 remains in OFF state. When the transistor Q12 is turned on, the voltage of the control electrode G is pulled down to the reference ground through the resistor R15 and the transistor Q12.

In actual battery management applications, when the voltage across the battery 20 rings or the voltage across the battery pack 100A rings, the bi-directional switch S1 may be mis-triggered. For example, when the pack terminals 50 of the battery pack 100 are connected to the external power supply and the battery 20 is charging, if the bi-directional switch S1 is turned off, a charging current flowing from the second electrode B to the first electrode A gradually decreases to zero. The voltage provided by the external power supply will increase. Since there are parasitic capacitances between the three terminals of the control electrode G, the first electrode A and the second electrode B, the increase in the voltage provided by the external power supply will cause a voltage drop between the control electrode G and the second electrode B to increase, the bi-directional switch S1 may be turned on falsely. This is dangerous and unacceptable.

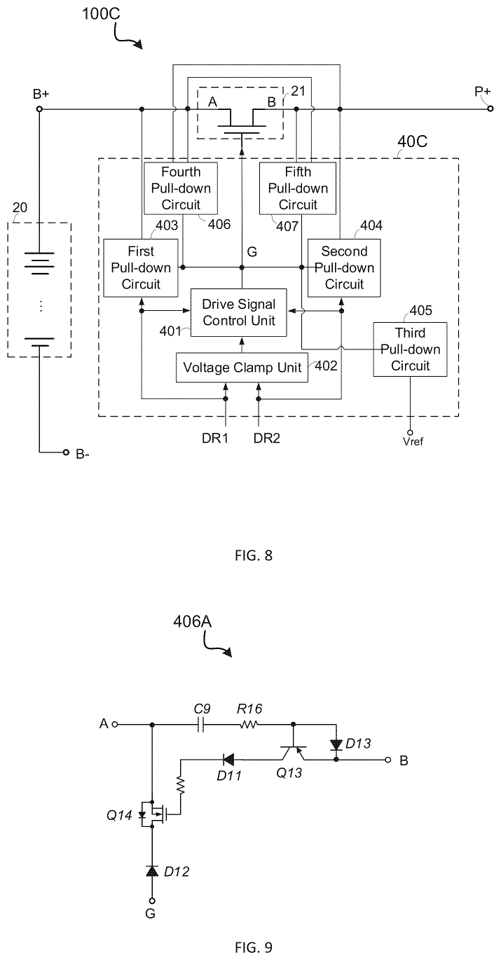

In order to prevent the mis-trigger of the bi-directional switch S1, the embodiment shown in FIG. 8 is proposed, and the bi-directional switch S1 can operate normally. FIG. 8 shows a battery pack 100C in accordance with one embodiment of the present invention. As shown in FIG. 8, the driver circuit 40C further comprises a fourth pull-down circuit 406 and a fifth pull-down circuit 407.

The fourth pull-down circuit 406 is configured to always pull the control electrode G of the bidirectional switch S1 reliably down to a low level, to prevent charging the battery 20 via the bi-directional switch S1. The fifth pull-up circuit 407 is configured to always pull the control electrode G reliably down to the low level, to prevent the battery 20 from being discharged via the bi-directional switch S1. In one embodiment, the fourth pull-down circuit 40C detects a voltage drop VBA between the second electrode B and the first electrode A, and provides a pull-down indication signal or a fourth pull-down path when the voltage drop VBA exceeds a first threshold voltage. When the voltage drop VBA increases to the first threshold voltage and continues to increase, the fifth pull-down path provided by the fourth pull-down circuit 406 is activated for providing a stable pull-down capability until the voltage drop VBA stops increasing or is maintained to be less than the first threshold voltage.

FIG. 9 shows a fourth pull-down circuit 406A in accordance with one embodiment of the present invention. As shown in FIG. 9, the fourth pull-down circuit 406A comprises transistors Q13 and Q14, voltage clamp elements D11˜D13, a resistor R16 and a capacitor C9. When a voltage drop VBA between the second electrode B and the first electrode A increases, and accordingly the transistor Q13 is turned on, a current flows through the second electrode B and the voltage clamp element D11, for charging a gate capacitance of the transistor Q14 until the transistor Q14 also is turned on. The voltage of the control electrode G is clamped to the voltage at the first electrode A, the bi-directional switch S1 is maintained in OFF state, to prevent false turning-on of the bi-directional switch S1. In one embodiment, when the voltage drop VBA increases to reach the first threshold voltage, the fourth pull-down path of the fourth pull-down circuit 406A is the fourth pull-down path is activated to control the second voltage drop being maintained equal to or lower than the first threshold voltage.

The fifth pull-down circuit 407 and the fourth pull-down circuit 406 have basically similar structures and working principles, which will not be described again for clarity.

Although the battery pack described above has the charge and discharge circuit is coupled between the positive terminal of the battery and the positive pack terminal P+ of the battery pack, it can be understood that the embodiment of the present invention can be applied with only slight changes.

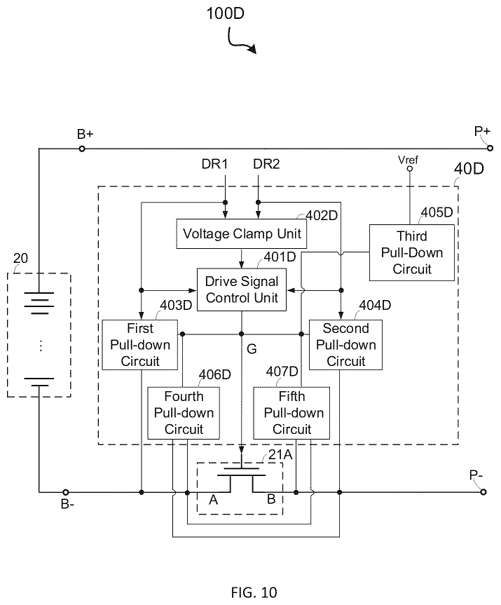

FIG. 10 shows a battery pack 100D in accordance with one embodiment of the present invention. As shown in FIG. 10, the charge and discharge circuit 21A is coupled between a negative terminal B− of the battery 20 and a negative pack terminal P− of the battery pack 100D. The driver circuit 40D shown in FIG. 10 is similar as the driver circuit 40C shown in FIG. 8, the driver circuit 40D comprises a drive signal control unit 401D, a voltage clamp unit 402D, a first pull-down circuit 403D, a second pull-down circuit 404D, a third pull-down circuit 405D, a fourth pull-down circuit 406D and a fifth pull-down circuit 407D. In the illustrated embodiment shown in FIG. 10, the reference voltage Vref is coupled to a negative voltage. When the bi-directional switch S1 in OFF state, the third pull-down circuit 405D is configured to pull the current from the control electrode G down to the negative voltage.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated, and they obviously will be resorted to by those skilled in the art without departing from the spirit and the scope of the invention as hereinafter defined by the appended claims as only a preferred embodiment(s) thereof has been disclosed.

What is claimed is:

1. A driver circuit for a battery pack with a monolithic bi-directional switch, wherein:
the driver circuit is configured to be coupled to a control electrode of the bi-directional switch and is configured to control the bi-directional switch based on a charge control signal and a discharge control signal, and
wherein a current is allowed to flow bi-directionally between a first electrode configured to be coupled to a battery and a second electrode configured to be coupled to a pack terminal when the bi-directional switch is turned on by the driver circuit, and there is no current flowing between the first electrode and the second electrode when the bi-directional switch is turned off by the driver circuit.

2. The driver circuit of claim 1, comprising:
a drive signal control unit configured to provide a driving path by transmitting a drive voltage to the control electrode for turning on the bi-directional switch in response to a first level of the charge control signal and a first level of the discharge control signal;
a first pull-down circuit configured to provide a first pull-down path for pulling the control electrode down to the first electrode to prevent charging to the battery via the bi-directional switch, in response to a second level of the charge control signal; and
a second pull-down circuit configured to provide a second pull-down path for pulling the control electrode down to the second electrode to prevent the battery from being discharged via the bi-directional switch, in response to a second level of the discharge control signal.

3. The driver circuit of claim 2, further comprising:
a voltage clamp unit having a first input terminal to receive the charge control signal, a second input terminal to receive the discharge control signal, and an output terminal, wherein the voltage clamp unit is configured to provide the drive voltage at the output terminal based on the charge control signal and the discharge control signal.

4. The driver circuit of claim 2, further comprising:
a third pull-down circuit configured to provide a third pull-down path for pulling the control electrode down to a reference node to keep a first voltage drop between the control electrode and the second electrode negative when the bi-directional switch is turned off.

5. The driver circuit of claim 4, further comprising:
a fourth pull-down circuit configured to provide a fourth pull-down path, wherein when a second voltage drop between the second electrode and the first electrode increases to reach a first threshold voltage, the fourth pull-down path is activated to control the second voltage drop being maintained equal to or lower than the first threshold voltage.

6. The driver circuit of claim 1, wherein the bi-directional switch comprises a wide bandgap semiconductor device.

7. A battery pack, comprising:
a monolithic bi-directional switch having a first electrode coupled to a battery, a second electrode coupled to a pack terminal, and a control electrode;
a battery management circuit configured to provide a charge control signal and a discharge control signal; and
a driver circuit coupled to the control electrode and configured to control the bi-directional switch based on the charge control signal and the discharge control signal, wherein a current is allowed to flow bi-directionally between the first electrode and the second electrode when the bi-directional switch is turned on by the driver circuit, and there is no current flowing between the first electrode and the second electrode when the bi-directional switch is turned off by the driver circuit.

8. The battery pack of claim 7, wherein the driver circuit comprising:
a drive signal control unit configured to provide a driving path by transmitting a drive voltage to the control electrode for turning on the bi-directional switch in response to a first level of the charge control signal and a first level of the discharge control signal;
a first pull-down circuit configured to provide a first pull-down path for pulling the control electrode down to the first electrode to prevent charging to the battery via the bi-directional switch, in response to a second level of the charge control signal; and
a second pull-down circuit configured to provide a second pull-down path for pulling the control electrode down to the second electrode to prevent the battery from being discharged via the bi-directional switch, in response to a second level of the discharge control signal.

9. The battery pack of claim 8, wherein the driver circuit further comprising:
a voltage clamp unit having a first input terminal to receive the charge control signal, a second input terminal to receive the discharge control signal, and an output terminal, wherein the voltage clamp unit is configured to provide the drive voltage at the output terminal based on the charge control signal and the discharge control signal.

10. The battery pack of claim 8, wherein the driver circuit further comprising:
a third pull-down circuit configured to provide a third pull-down path for pulling the control electrode down to a reference node to keep a first voltage drop between the control electrode and the second electrode negative when the bi-directional switch is turned off.

11. The battery pack of claim 9, wherein the driver circuit further comprising:
a fourth pull-down circuit configured to provide a fourth pull-down path, wherein when a second voltage drop between the second electrode and the first electrode increases to reach a first threshold voltage, the fourth pull-down path is activated to control the second voltage drop being maintained equal to or lower than the first threshold voltage.

12. The battery pack of claim 7, wherein the bi-directional switch comprises a wide bandgap semiconductor device.

13. The battery pack of claim 7, wherein the first electrode is coupled to a positive terminal of the battery, the second electrode is coupled to a positive pack terminal of the battery pack.

14. The battery pack of claim 7, wherein the first electrode is coupled to a negative terminal of the battery, the second electrode is coupled to a negative pack terminal of the battery pack.

15. A control method for a battery pack with a monolithic bi-directional switch, the control method comprising:
providing a charge control signal and a discharge control signal; and
controlling the bi-directional switch based on the charge control signal and the discharge control signal, wherein the bi-directional switch has a first electrode coupled to a battery, a second electrode coupled to a pack terminal, and a control electrode, and wherein a current is allowed to flow bi-directionally between the first electrode and the second electrode when the bi-directional switch is turned on, and there is no current flowing between the first electrode and the second electrode when the bi-directional switch is turned off.

16. The control method of claim 15, further comprising:
providing a driving path by transmitting a drive voltage to the control electrode for turning on the bi-directional switch in response to a first level of the charge control signal and a first level of the discharge control signal;
providing a first pull-down path for pulling the control electrode down to the first electrode to prevent charging to the battery via the bi-directional switch, in response to a second level of the charge control signal; and
providing a second pull-down path for pulling the control electrode down to the second electrode, to prevent the battery from being discharged via the bi-directional switch, in response to a second level of the discharge control signal.

17. The control method of claim 16, wherein the drive voltage is provided based on the charge control signal and the discharge control signal.

18. The control method of claim 15, when the bi-directional switch is turned off, the method further comprising:
providing a third pull-down path for pulling the control electrode down to a reference node to keep a first voltage drop between the control electrode and the second electrode negative.

19. The control method of claim 15, further comprising:
providing a fourth pull-down path; and
when a second voltage drop between the second electrode and the first electrode increases to reach a first threshold voltage, activating the fourth pull-down path to control the second voltage drop being maintained equal to or lower than the first threshold voltage.

20. The control method of claim 15, wherein the bi-directional switch comprises a wide bandgap semiconductor device.
